(19) United States
(12) Patent Application Publication
(10) Pub. No.: US 2013/0101819 A1
(43) Pub. Date: Apr. 25, 2013

(54) DOUBLE-SIDED ADHESIVE TAPE

(71) Applicants: Toshihide SUZUKI, Osaka (JP); Yoshikazu SOEDA, Osaka (JP); Akinori TAMURA, Osaka (JP); Naoki NAKAYAMA, Osaka (JP)

(72) Inventors: Toshihide SUZUKI, Osaka (JP); Yoshikazu SOEDA, Osaka (JP); Akinori TAMURA, Osaka (JP); Naoki NAKAYAMA, Osaka (JP)

(21) Appl. No.: 13/655,689

(22) Filed: Oct. 19, 2012

(30) Foreign Application Priority Data
Oct. 20, 2011 (JP) 2011-230989
Sep. 20, 2012 (JP) 2012-206900

(51) Int. Cl. C09J 7/02; B32B 7/02

(52) U.S. Cl. 428/214; 428/337

(57) ABSTRACT

A double-sided adhesive tape comprises: a base member configured as a non-foamed thermoplastic film having a thickness of 50 μm or more; and acrylic pressure-sensitive adhesive layers provided to both faces of the base member. The double-sided adhesive tape has a 50% modulus ranging from 3.0 MPa or more to 40.0 MPa or less.

### BACKGROUND OF THE INVENTION

1. Field of the Invention

The present invention relates to a double-sided adhesive tape, and particularly to a double-sided adhesive tape employed in affixation of components of a portable electronic device.

2. Description of the Related Art

In portable electronic devices such as cellular phone terminals, PHS, digital cameras, electronic organizers, portable music players, portable game machines, smart phones, tablet personal computers, and so forth, double-sided adhesive tapes are used in bonding and affixing various kinds of components or modules, such as the affixation of a display panel arranged on the front face of an image display module or a lens on a casing, the affixation of LCD components, and so forth.

As a double-sided adhesive tape for affixing components of such a portable electronic device, for example, Patent document 1 discloses a double-sided adhesive tape manufactured using a foamed base material, which provides improved waterproofness. Furthermore, Patent document 2 discloses a double-sided adhesive tape employing polyethylene terephthalate (PET) as a base material.

### PATENT DOCUMENTS

### Patent Document 1

Japanese Patent Application Laid Open No. 2010-155969 [Patent Document 2]
Japanese Patent Application Laid Open No. 2011-006608

In recent years, with cellular phone terminals, smart phones, and so forth, the image display area is becoming larger. As the display area has been becoming larger, an adhesive space for the double-sided adhesive tape has been becoming smaller. Thus, there is a demand for a double-sided adhesive tape of which at least a part has a narrow width on the order of 1 mm or less. However, such a double-sided adhesive tape having the aforementioned foamed base material has a problem in that such a foamed base material deforms due to pressure applied when punching is performed for the double-sided adhesive tape. Thus, such a punching process does not provide sufficient processing accuracy for providing a tape width of 1 mm or less, leading to difficulty in providing such a double-sided adhesive tape having a desired shape.

On the other hand, there is another demand for a thick double-sided adhesive tape having a thickness of 100 μm or more. Examples of conceivable methods for providing such a thick double-sided adhesive tape include a method in which an pressure-sensitive adhesive layer having an increased thickness is employed or otherwise a method in which a base material having an increased thickness is employed. In a case in which an pressure-sensitive adhesive layer having an increased thickness is employed, in some cases, such a method leads to degraded drying efficiency or otherwise leads to reduced productivity. Thus, in order to provide such a thick double-sided adhesive tape, a base material having an increased thickness is preferably employed. However, in a case of using such a method in which a base material having an increased thickness is applied to the aforementioned double-sided adhesive tape having a PET base material, such a double-sided adhesive tape has excessive rigidity, leading to a problem in that it is difficult for such a double-sided adhesive tape to fit and adhere to the surface of an adhesion target. For example, in a case in which such an adhesion target has a curved surface, it is difficult for such a double-sided adhesive tape to be tightly adhered to the surface of the adhesion target without it lifting off or coming unstuck.

That is to say, in a case of employing a foamed base material, such an arrangement avoids a problem of increased tape rigidity due to an increase in the thickness of the base material. Thus, such an arrangement provides improved adhesion to an adhesion target even if the thickness of the double-sided adhesive tape is increased. However, in a case of manufacturing a double-sided adhesive tape having a narrow-width part, such an arrangement has a problem of poor workability. On the other hand, an arrangement employing a PET base material has an advantage of little deformation occurring due to the pressure applied in the punching process, thereby providing improved workability in manufacturing of a double-sided adhesive tape having such a narrow-width part. However, in a case of increasing the thickness of such a double-sided adhesive tape, such an arrangement employing a PET base material leads to a problem of poor adhesion to an adhesion target.

### SUMMARY OF THE INVENTION

The present invention has been made in order to solve such a problem. Accordingly, it is a general purpose of the present invention to provide a technique for providing both improved adhesion to an adhesion target even if the double-sided adhesive tape is manufactured with an increased thickness and improved workability in the manufacturing process even if the double-sided adhesive tape has a narrow-width part.

An embodiment of the present invention relates to a double-sided adhesive tape. The double-sided adhesive tape comprises: a base member having a thickness that is equal to or greater than 50 μm formed of non-foamed thermoplastic film; and acrylic pressure-sensitive adhesive layers respectively provided to both faces of the base member. The double-sided adhesive tape is configured to have a 50% modulus ranging from 3.0 MPa or more to 40.0 MPa or less.

The double-sided adhesive tape according to the embodiment provides an advantage of adhesion to an adhesion target even if the double-sided adhesive tape is configured as a thick tape, and an advantage of workability in the manufacturing process for the double-sided adhesive tape even if it has a narrow-width part.

Also, with the double-sided adhesive tape according to the aforementioned embodiment, the total thickness of the acrylic pressure-sensitive adhesive layers respectively provided to both faces of the base member may be within a range of 5 μm or more to 200 μm or less. Also, the total thickness of the base member and the acrylic pressure-sensitive adhesive layers may be equal to or greater than 100 μm.

Also, with the double-sided adhesive tape according to the aforementioned embodiment, the thermoplastic film may contain at least one resin selected from a group that comprises a flexible polyolefin resin, a flexible urethane resin, a flexible acrylic resin, a flexible polyester resin, and a flexible vinyl chloride resin. Also, the base member may contain substantially no halogen compound. Also, the double-sided adhesive tape according to the aforementioned embodiment may be employed in the affixation of components of a portable electronic device.

Also, with the double-sided adhesive tape according to the aforementioned embodiment, the base member may be configured in black. Also, the double-sided adhesive tape may be configured to have a visible light transmissivity that is equal to or smaller than 15%.

Also, with the double-sided adhesive tape according to the aforementioned embodiment, the base member may be configured in white. Also, the double-sided adhesive tape may be configured to have a visible light reflectivity that is equal to or greater than 20%.

It should be noted that the aforementioned components as described above may be appropriately combined, which is encompassed by the scope of the present invention protected by the present patent application.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic cross-sectional diagram which shows a structure of a double-sided adhesive tape according to an embodiment; and

FIG. 2A is a schematic diagram showing a method for a loop repulsion test, and FIG. 2B is an enlarged view of the region A shown in FIG. 2A surrounded by the broken line.

### DETAILED DESCRIPTION OF THE INVENTION

The invention will now be described by reference to the preferred embodiments. This does not intend to limit the scope of the present invention, but to exemplify the invention.

Description will be made regarding preferred embodiments of the present invention with reference to the drawings. The embodiments have been described for exemplary purposes only, and are by no means intended to restrict the present invention. Also, it is not necessarily essential for the present invention that all the features or a combination thereof be provided as described in the embodiments.

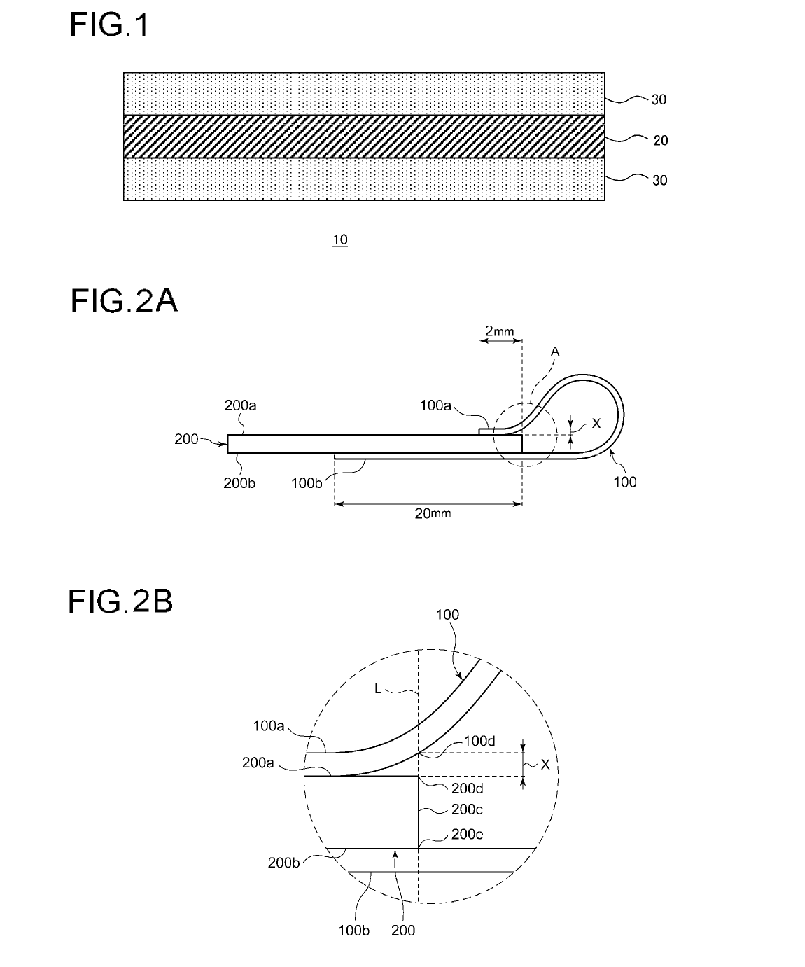

FIG. 1 is a schematic cross-sectional diagram which shows a structure of a double-sided adhesive tape according to an embodiment. As shown in FIG. 1, a double-sided adhesive tape 10 according to the present embodiment includes a base member 20, and acrylic pressure-sensitive adhesive layers 30 provided to both faces of the base material. The double-sided adhesive tape 10 is preferably employed in the affixation of components of a portable electronic device. Detailed description will be made below regarding each component of the double-sided adhesive tape 10.

### [Base Member]

The base member 20 is a sheet-shaped base member composed of a non-foamed thermoplastic film. By configuring the base member 20 as a non-foamed thermoplastic film, such an arrangement ensures satisfactory workability even if a double-sided adhesive tape is manufactured so as to have a narrow-width part having a width of 1 mm or less, or otherwise to have a such a narrow width of 1 mm or less over its entire length.

The thermoplastic film of which the base member 20 is composed preferably contains at least one resin selected from a group that is composed of flexible polyolefin resin, flexible urethane resin, flexible acrylic resin, flexible polyester resin such as polybutylene terephthalate resin, etc., and flexible vinyl chloride resin. By configuring the base member 20 as a thermoplastic film containing the aforementioned flexible resin, such an arrangement allows the 50% modulus of the double-sided adhesive tape 10 to be easily adjusted to be in a range from 3.0 MPa or more to 40.0 MPa or less. Examples of the base member 20 include: a flexible polyolefin resin sheet composed of flexible polyolefin resin; a flexible urethane resin sheet composed of flexible urethane resin; a flexible acrylic resin sheet composed of flexible acrylic resin; a flexible polyester resin sheet (flexible polyester film) composed of flexible polyester resin; or otherwise a flexible vinyl chloride resin sheet composed of vinyl chloride resin.

Specific examples of a thermoplastic film of which the base member 20 is composed include: EMMA (ethylene methyl-methacrylate copolymer) resin; an olefin resin sheet mainly composed of EVA (ethylene ethylene-vinyl acetate copolymer); a polyethylene resin sheet composed of at least one from among low-density polyethylene, linear low-density polyethylene containing an α-olefin component, and so forth; a polyolefin resin sheet composed of at least one from among propylene polymer (homopolymer, block polymer, random polymer), propylene polymer reactor-blended with a rubber component, ethylene-propylene copolymer, propylene α-olefin copolymer, ethylene propylene α-olefin copolymer, and so forth; and a vinyl chloride resin sheet. It should be noted that the base member 20 may be formed by mixing two or more kinds of resins that are components of the aforementioned resin sheets.

In a case in which the polyolefin resin sheet contains polyethylene resin, the polyolefin resin sheet preferably contains polyethylene resin with a concentration of 30% by weight or more, and more preferably with a concentration of 50% by weight or more, and even more preferably with a concentration of 70% by weight or more. In a case in which the polyolefin resin sheet contains polyethylene resin with a concentration that is smaller than 30% by weight, such an arrangement leads to reduced anchoring strength in the initial adhesion to an adhesion target. With such an arrangement, even if the adhesive tape is manufactured to have improved adhesive performance, or otherwise even if the pressure-sensitive adhesive force rises with the passage of time, in many cases, such an arrangement leads to a problem of the occurrence of pressure-sensitive adhesive agent residue. Also, the resin layer (support member) may be configured as a drawn resin or otherwise a non-drawn resin layer.

In many cases, portable electronic devices are required to employ components formed of material that includes no halogen compound. Thus, the base member 20 preferably contains substantially no halogen compound. Thus, the base member 20 is preferably configured as a flexible polyolefin resin sheet or a flexible urethane resin sheet, and particularly is more preferably configured as a flexible polyolefin resin sheet.

In order to provide improved adhesion between the base member 20 and the acrylic pressure-sensitive adhesive layer 30, the base member 20 is preferably subjected to processing such as corona treatment, primer coating, or the like. Furthermore, the base member 20 is formed with a thickness of 50 μm (0.050 mm) or more, and is preferably formed with a thickness of 100 μm or more. Moreover, the base member 20 is preferably formed with a thickness of 1200 μm or less. By configuring the base member 20 with a thickness of 50 μm or more, such an arrangement can avoid a need to increase the thickness of the acrylic pressure-sensitive adhesive layer 30 in a case in which the double-sided adhesive tape 10 having a large thickness is manufactured. Thus, such an arrangement can avoid degradation of the drying efficiency of, and reduction in productivity in the manufacturing process for, the double-sided adhesive tape.

The base member 20 can be formed in black. By configuring the base member 20 in black, the double-sided adhesive tape can be used for light shielding. In this case, the base member 20 is preferably configured to have L* (lightness) of 35 or less (0 to 35) stipulated in the L*a*b* color system, and is more preferably configured to have L* of 30 or less (0 to 30). It should be noted that the other factors, i.e., a* and b* stipulated in the L*a*b* color system can each be selectively determined according to the value of L*. The factors a* and b* are each preferably set to a value ranging from −10 or more to 10 or less, more preferably set to a value ranging from −5 or more to 5 or less, even more preferably set to a value ranging from −2.5 or more to 2.5 or less, and optimally set to zero.

It should be noted that, with the present embodiment, the values of L*, a*, and b* can be measured by using a color-difference meter (such as a device manufactured by Konica Minolta, trade name “CR-200”), for example. It should be noted that the L*a*b* color system is a color system recommended by the Commission Internationale de l'Éclairage (CIE) in 1976, which represents a color space which is referred to as “CIE 1976 (L*a*b*) color system”. Furthermore, the L*a*b* color system is stipulated in JIS Z 8729, which is a Japanese Industrial Standard.

Examples of black coloring agents to be used to configure the base member 20 in black include carbon black (furnace black, channel black, acetylene black, thermal black, lamp black, and so forth), graphite, copper oxide, manganese dioxide, aniline black, perylene black, black titanium oxide, cyanine black, activated charcoal, ferrite (non-magnetic ferrite, magnetic ferrite, and so forth), magnetite, chromic oxide, iron oxide, molybdenum disulfide, chromium complex, composite oxide black pigment, anthraquinone organic black pigment, and so forth. Among these black coloring agents, carbon block is preferably employed from the viewpoint of costs and availability.

The amount of such a black coloring agent is not restricted in particular. A suitable amount of the black coloring agent is applied to the double-sided adhesive tape 10 according to the present embodiment so as to provide desired optical characteristics. Examples of methods for coloring the base member 20 include: a method in which a filler, a pigment, and so forth, are added to a thermoplastic film of which the base member 20 is composed so as to color the base member 20; and a method in which black printing is applied to the surface of a thermoplastic film.

In a case in which the double-sided adhesive tape 10 is used for light shielding, the double-sided adhesive tape 10 preferably has a visible light transmissivity of 15% or less, more preferably has a visible light transmissivity of 10% or less, even more preferably has a visible light transmissivity of 5% or less, still more preferably has a visible light transmissivity of 1% or less, and optimally has a visible light transmissivity of 0.1% or less. Here, the visible light transmissivity represents a light transmissivity for light with a wavelength of 550 nm. By configuring the double-sided adhesive tape 10 to have a visible light transmissivity of 15% or less, such an arrangement provides the double-sided adhesive tape 10 with a satisfactory light shielding performance.

The base member 20 can be formed in white. By configuring the base member 20 in white, the double-sided adhesive tape can be used for reflecting light. In this case, the base member 20 is preferably configured to have L* (lightness) of 87 or more (87 to 100) stipulated in the L*a*b* color system. It should be noted that the other factors, i.e., a* and b* stipulated in the L*a*b* color system can each be selectively determined according to the value of L*. The factors a* and b* are each preferably set to a value ranging from −10 or more to 10 or less, more preferably set to a value ranging from −5 or more to 5 or less, even more preferably set to a value ranging from −2.5 or more to 2.5 or less, and optimally set to zero.

Examples of white coloring agents to be used to configure the base member 20 in white include: inorganic white coloring agents such as titanium oxide (titanium dioxide such as rutile type titanium dioxide, anatase-type titanium dioxide), zinc oxide, aluminum oxide, silicon oxide, zirconium oxide, magnesium oxide, calcium oxide, tin oxide, barium oxide, cesium oxide, yttrium oxide, magnesium carbonate, calcium carbonate (light calcium carbonate, heavy calcium carbonate, and so forth), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc white, zinc sulfide, talc, silica, alumina, clay, kaolin, titanium phosphate, mica, gypsum, white carbon, diatom earth, bentonite, lithopone, zeolite, sericite, hydro-halloysite, and so forth; and organic white coloring agents such as acrylic resin powder, polystyrene resin powder, polyurethane resin powder, amide resin powder, polycarbonate resin powder, silicone resin powder, urea-formalin resin powder, melamine resin powder, and so forth.

The amount of such a white coloring agent is not restricted in particular. A suitable amount of the white coloring agent is applied to the double-sided adhesive tape 10 according to the present embodiment so as to provide desired optical characteristics. Examples of methods for coloring the base member 20 include: a method in which a filler, a pigment, and so forth, are added to a thermoplastic film of which the base member 20 is composed so as to color the base member 20; and a method in which white printing is applied to the surface of a thermoplastic film.

In a case in which the double-sided adhesive tape 10 is used for light reflecting, the double-sided adhesive tape 10 preferably has a visible light reflectivity of 20% or more, more preferably has a visible light reflectivity of 40% or more, and even more preferably has a visible light reflectivity of 60% or more. Here, the visible light reflectivity represents a reflectivity for light with a wavelength of 550 nm. By configuring the double-sided adhesive tape 10 to have a visible light reflectivity of 20% or more, such an arrangement provides the double-sided adhesive tape 10 with a satisfactory light reflecting performance.

The base member 20 may be configured to have one main surface in black and the other main surface in white. Such a base member 20 can be manufactured by performing white printing processing on one main surface of the base member 20 configured in black, or otherwise by performing black printing processing on one main surface of the base member 20 configured in white. Otherwise, such a base member 20 can be manufactured by performing black printing processing on one main surface of a transparent base member 20, and by performing white printing processing on the other main surface thereof.

### [Acrylic Pressure-Sensitive Adhesive Layer]

The acrylic pressure-sensitive adhesive composition of which the acrylic adhesive layer 30 is composed may be configured to have a desired suitable composition. Examples of pressure-sensitive adhesive compositions which can be employed include emulsion pressure-sensitive adhesive composition, solvent-based pressure-sensitive adhesive composition, solventless pressure-sensitive adhesive composition (ultraviolet cure pressure-sensitive adhesive composition), hot-melt pressure-sensitive adhesive composition, and so forth.

The composition of the acrylic pressure-sensitive adhesive composition of which the acrylic adhesive layer 30 is composed is not restricted in particular. As the composition of such an acrylic pressure-sensitive adhesive, such an arrangement may employ a composition containing, as a base polymer, an acrylic polymer containing alkyl ester (meth)acrylate as an essential monomer component (principal monomer component), and obtained as necessary by polymerizing the monomer component and a copolymerization monomer that can be copolymerized with the aforementioned principal monomer component. Examples of such copolymerization monomer include polar group-containing monomer, polyfunctional monomer, and so forth, described later. The polymerization method is not restricted in particular. Rather, conventional known methods such as a UV polymerization method, solution polymerization method, emulsion polymerization method, and so forth, can be employed. It should be noted that alkyl ester (meth)acrylate represents alkyl ester acrylate and/or alkyl ester methacrylate. The prefix “(meth)” as used here represents the same meaning for all the cases.

The alkyl ester (meth)acrylate, which is employed as a principal monomer component of the aforementioned acrylic polymer is configured as alkyl ester (meth)acrylate having a straight-chain or branched-chain alkyl group. Such an arrangement employs C₁₋₂₀ alkyl ester (meth)acrylate, examples of which include methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexsadecyl (meth)acrylate, heptadecyl (meth)acrylate, octadecyl (meth)acrylate, nonadecyl (meth)acrylate, eicosyl (meth)acrylate, and so forth. Furthermore, such an arrangement preferably employs C₂₋₁₄ alkyl ester (meth)acrylate, and more preferably employs C₂₋₁₀ alkyl ester (meth)acrylate.

In order to adjust the acrylic polymer, the alkyl ester (meth)acrylate is applied preferably with a concentration of 60% or more by weight, and more preferably with a concentration of 80% or more by weight with respect to the entire amount of the monomer components.

The aforementioned acrylic polymer may contain, as a monomer component, various kinds of copolymerization monomer such as a polar group-containing monomer, polyfunctional monomer, etc. By employing such a copolymerization monomer as a monomer component, such an arrangement provides improved adhesion to an adhesion target or otherwise provides improved cohesion of the pressure-sensitive adhesive, for example. It should be noted that such a single kind of copolymerization monomer may be employed. Also, two or more kinds of copolymerization monomer may be employed.

Examples of such a polar group-containing monomer include: carboxyl-containing monomer or its anhydride such as (meth)acrylic acid, itaconic acid, maleic acid, fumaric acid, crotonic acid, isocrotonic acid, etc.; hydroxyl-containing monomer such as hydroxyethyl (meth)acrylate, hydroxypropyl (meth)acrylate, hydroxybutyl (meth)acrylate, etc.; amide-containing monomer such as acrylamide, methacrylamide, N,N-dimethyl acrylamide, N-methylol (meth)acrylamide, N-methoxymethyl (meth)acrylamide, N-butoxymethyl (meth)acrylamide, etc.; amino-containing monomer such as aminoethyl (meth)acrylate, dimethylaminoethyl (meth)acrylate, t-butylaminoethyl (meth)acrylate, etc.; glycidyl-containing monomer such as glycidyl (meth)acrylate, methylglycidyl (meth)acrylate, etc.; cyano group-containing monomer such as acrylic nitrile, methacrylic nitrile, etc.; heterocyclic group-containing vinyl monomer such as N-vinyl-2-pyrolidone, (meth)acryloyl morpholine, N-vinylpyridine, N-vinylpiperidone, N-vinylpyrimidine, N-vinylpiperazine, N-vinylpyrrol, N-vinylimidazole, N-vinyloxazole, etc.,; alkoxyalkyl (meth)acrylate monomer such as methoxyethyl (meth)acrylate, ethoxyethyl (meth)acrylate, etc.; sulfonate-containing monomer such as sodium ethenesulfonate etc.; phosphate-containing monomer such as 2-hydroxyethyl acryloyl phosphate etc.; imido-containing monomer such as cyclohexylmaleimide, isopropylmaleimide, etc.; isocyanate-containing monomer such as 2-methacryloyloxyethyl isocyanate etc., and so forth.

As such a polar group-containing monomer, carboxyl-containing monomer such as acrylic acid or the like, or otherwise its anhydride, is preferably employed. The polar group-containing monomer is applied preferably with a concentration of 1% by weight or more to 30% by weight or less, and more preferably with a concentration of 1% by weight or more to 15% by weight or less with respect to the entire amount of the monomer components used to form the acrylic polymer. By applying such a polar group-containing monomer with a concentration of 30% or less by weight with respect to the entire amount of the monomer components used to form such an acrylic polymer, such an arrangement avoids a problem of such an acrylic pressure-sensitive adhesive composition exhibiting excessive cohesion, thereby suppressing reduction in the adhesion of the acrylic pressure-sensitive adhesive layer 30. Furthermore, by applying such a polar group-containing monomer with a concentration of 1% or more by weight with respect to the entire amount of the monomer components used to form such an acrylic polymer, such an arrangement avoids a problem of such an acrylic pressure-sensitive adhesive composition exhibiting insufficient cohesion, thereby providing the acrylic pressure-sensitive adhesive layer 30 with satisfactory shearing rigidity.

Examples of such multifunctional monomer include hexanediol di-(meth)acrylate, butanediol di-(meth)acrylate, (poly-)ethylene glycol di-(meth)acrylate, (poly-)propylene glycol di-(meth)acrylate, neopentyl glycol glycol di-(meth)acrylate, pentaerythritol di-(meth)acrylate, pentaerythritol tri-(meth)acrylate, di-pentaerythritol hexa-(meth)acrylate, trimethylolpropane tri-(meth)acrylate, tetramethylolmethane tri-(meth)acrylate, ally(meth)acrylate, vinyl(meth)acrylate, divinylbenzene, epoxy acrylate, polyester acrylate, urethane acrylate, and so forth.

The multifunctional monomer is applied preferably with a concentration of 2% or less by weight with respect to the entire amount of the monomer components used to prepare such an acrylic polymer. For example, the multifunctional monomer is applied with a concentration of 0.01% to 2% by weight with respect to the entire amount of the monomer components used to prepare an acrylic polymer, and is preferably applied with a concentration of 0.02% to 1% by weight. By applying such multifunctional monomer with a concentration of 2% or less by weight with respect to the entire amount of the monomer components used to prepare such an acrylic polymer, such an arrangement avoids a problem of such an acrylic pressure-sensitive adhesive composition exhibiting excessive cohesion, thereby suppressing reduction in the adhesion of the acrylic pressure-sensitive adhesive layer 30. Furthermore, by applying such a multifunctional monomer with a concentration of 0.01% or more by weight with respect to the entire amount of the monomer components used to prepare such an acrylic polymer, such an arrangement avoids a problem of such an acrylic pressure-sensitive adhesive composition exhibiting insufficient cohesion.

Furthermore, examples of a copolymerization monomer other than the aforementioned polar group-containing monomer and polyfunctional monomer include: vinyl ester such as vinyl acetate, vinyl propionate, etc.; aromatic vinyl such as styrene, α-methyl-styrene, vinyl toluene, etc.; (meth)acrylic acid ester of cyclic alcohol such as cyclopentyl (meth)acrylate, cyclohexyl (meth)acrylate, isobornyl (meth)acrylate, etc.; ethylene unsaturated monomer such as (meth)acrylonitrile, N-(meth)acryloyl morpholine, N-vinyl-2-pyrrolidone, etc.; olefin or diene such as ethylene, butadiene, isoprene, isobutylene, etc.; and vinyl ether such as vinyl alkyl ether, etc.

Such an acrylic pressure-sensitive adhesive composition may contain an additive agent depending on the usage. Examples of such additive agents include a cross-linking agent (e.g., polyisocyanate cross-linking agent, silicone cross-linking agent, epoxy cross-linking agent, alkyl ether melamine cross-linking agent, etc.), tackifier (e.g., rosin derivative resin, polyterpene resin, petroleum resin, oil-soluble phenol resin, etc., which is solid, semisolid, or otherwise liquid at room temperature), plasticizing agent, filler, anti-aging agent, anti-oxidizing agent, coloring agent (pigment or dye such as carbon black etc.), etc.

The acrylic pressure-sensitive adhesive composition of which the acrylic pressure-sensitive adhesive layer 30 is composed can be prepared by mixing the aforementioned base polymer and various kinds of additive agents or the like to be applied depending on the usage, using known methods. The method for forming the acrylic pressure-sensitive adhesive layer 30 is not restricted in particular. Examples of such methods include a method in which an acrylic pressure-sensitive adhesive composition is applied to the base member 20 or otherwise a release liner described later, thereby forming the acrylic pressure-sensitive adhesive layer 30. With such a forming method, heating, drying, or the like may be performed as necessary.

The total thickness of the acrylic pressure-sensitive adhesive layers 30 provided to both faces of the base member 20 is preferably set to 5 μm or more to 200 μm or less, more preferably set to 10 μm or more to 170 μm or less, even more preferably set to 10 μm or more to 150 μm or less, and optimally set to 20 μm or more to 100 μm or less. By setting the total thickness of the acrylic pressure-sensitive adhesive layers 30 to be 5 μm or more, such an arrangement secures the adhesive characteristics of the acrylic pressure-sensitive adhesive layer 30. Furthermore, by setting the total thickness of the acrylic pressure-sensitive adhesive layers 30 to be 200 μm or less, such an arrangement secures the drying efficiency of the acrylic pressure-sensitive adhesive layer 30 and the productivity of the double-sided adhesive tape 10, and suppresses degradation of the workability of the double-sided adhesive tape 10. It should be noted that the two acrylic pressure-sensitive adhesive layers 30 have the same thickness, or otherwise different thicknesses. The thickness of each acrylic pressure-sensitive adhesive layer 30 is not restricted in particular. For example, the thickness of each acrylic pressure-sensitive adhesive layer is set to 2.5 μm or more to 100 μm or less, preferably set to 10 μm or more to 80 μm or less, and more preferably set to 15 μm or more to 70 μm or less. Also, each acrylic pressure-sensitive adhesive layer 30 may be configured as a single-layer structure or otherwise as a multilayer structure.

### [Double-Sided Adhesive Tape]

With such a double-sided adhesive tape 10, the sum total of the thickness (total thickness) of the base member 20 and the acrylic pressure-sensitive adhesive layers 30 is preferably set to 100 μm (0.100 mm) or more, and is more preferably set to 150 μm or more. Furthermore, the upper limit of the total thickness of the double-sided adhesive tape 10 is not restricted in particular. For example, the double-sided adhesive tape 10 may be configured to have a total thickness of 1.2 mm or less. Moreover, the upper limit of the total thickness of the double-sided adhesive tape 10 is preferably set to 1 mm or less, more preferably set to 800 μm or less, and even more preferably set to 250 μm or less.

Furthermore, the 50% modulus of the double-sided adhesive tape 10 is set to 3.0 MPa or more to 40.0 MPa or less, preferably set to 5.0 MPa or more to 30.0 MPa or less, and more preferably set to 10.0 MPa or more to 20.0 MPa or less. By configuring the double-sided adhesive tape 10 to have a 50% modulus of 3.0 MPa or more, such an arrangement can avoid a problem of the double-sided adhesive tape 10 exhibiting insufficient bending strength, thereby suppressing degradation of the workability of the double-sided adhesive tape 10. Furthermore, by configuring the double-sided adhesive tape 10 to have a 50% modulus of 40.0 MPa or less, such an arrangement can avoid a problem of the double-sided adhesive tape 10 exhibiting excessive rigidity for usage as a tape. Such an arrangement is capable of preventing the double-sided adhesive tape 10 from lifting off or coming unstuck due to the repulsive force of the double-sided adhesive tape 10.

Before usage of the double-sided adhesive tape 10, i.e., before the double-sided adhesive tape 10 is adhered to an adhesion target, a release liner (separator) configured as a release sheet base member may be provided to the surface of the acrylic pressure-sensitive adhesive layer 30. The double-sided adhesive tape 10 may be configured such that both main faces are protected by two respective release liners. Also, the double-sided adhesive tape 10 may be configured such that a single release liner having both faces respectively configured as release faces is provided to one of its main faces, and the tape is wound in the form of a roll so as to protect both main faces of the double-sided adhesive tape 10. That is to say, the double-sided adhesive tape 10 may be configured as a so-called double separator type structure in which a release liner, the acrylic pressure-sensitive adhesive layer 30, the base member 20, the acrylic pressure-sensitive adhesive layer 30, and a release liner are layered in this order. Also, the double-sided adhesive tape 10 may be configured as a so-called single separator type structure in which the acrylic pressure-sensitive adhesive layer 30, the base member 20, the acrylic pressure-sensitive adhesive layer 30, and a release liner are layered in this order.

The release liner is employed as a protecting member for the acrylic pressure-sensitive adhesive layer 30. Before the double-sided adhesive tape 10 is adhered to an adhesion target, the release liner is peeled off. Examples of materials employed as such a release liner include glassine paper, kraft paper, clay-coated paper, paper having been laminated with a polyethylene film or the like, paper having been coated with a resin such as polyvinyl alcohol, acrylic acid ester copolymer, or the like, a member obtained by coating a synthetic resin or the like such as polyester, polypropylene, or the like, with a release agent such as fluorine resin, silicone resin, or the like. It should be noted that such a release liner is not indispensable for the double-sided adhesive tape 10.

It should be noted that, in a case in which such a release liner is layered on the surface of each acrylic pressure-sensitive adhesive layer 30 of the double-sided adhesive tape 10, the two release liners to be layered on the respective faces of the double-sided adhesive tape 10 are preferably configured to have different respective peeling forces. For example, the release liner which is to be peeled off first is preferably configured to have a peeling force that is smaller than that of the other release liner which is to be peeled off next.

The double-sided adhesive tape 10 can be manufactured using various kinds of methods. For example, one main face of the base member 20 is coated with an acrylic pressure-sensitive adhesive composition, the acrylic pressure-sensitive adhesive composition is dried, and a release liner is adhered to the main face of the acrylic pressure-sensitive adhesive layer 30 thus formed. The same procedure is applied to the other main face of the base member 20, thereby forming the double-sided adhesive tape 10.

Alternatively, the face of a release liner subjected to release processing is coated with an acrylic pressure-sensitive adhesive composition, and the acrylic pressure-sensitive adhesive composition thus applied is dried so as to form the acrylic pressure-sensitive adhesive layer 30. Next, the base member 20 is adhered to the main face of the acrylic pressure-sensitive adhesive layer 30 thus formed, thereby forming a layered member A having a structure in which the release liner, the acrylic pressure-sensitive adhesive layer 30, and the base member 20 are layered in this order. Furthermore, the face of another release liner subjected to release processing is coated with an acrylic pressure-sensitive adhesive composition, and the acrylic pressure-sensitive adhesive composition thus applied is dried, thereby forming a layered member B having a structure in which the release liner and the acrylic pressure-sensitive adhesive layer 30 are layered in this order. Subsequently, the layered member A and the layered member B are stacked such that the acrylic pressure-sensitive adhesive layer 30 of the layered member B faces the base member 20 of the layered member A, thereby forming the double-sided adhesive tape 10.

The coating applicator to be used to coat the base member 20 or otherwise the release liner with an acrylic pressure-sensitive adhesive composition may be an ordinarily available coating applicator, and is not restricted in particular. Examples of such coating applicators include a roll knife coater, die coater, roll coater, bar coater, rotogravure coater, reverse roll coater, dipping coater, blade coater, and so forth. The drying conditions for the acrylic pressure-sensitive adhesive composition after coating are not restricted in particular as long as the solvent of the acrylic pressure-sensitive adhesive composition and residual monomer are removed and a cross-linking agent can be reacted with the functional groups contained in the acrylic copolymer so as to form a bridge structure after the drying processing. As such a drying condition, the acrylic pressure-sensitive adhesive composition is preferably dried at 60° C. to 120° C. for a period of time on the order of 1 to 5 minutes. It should be noted that the acrylic pressure-sensitive adhesive layers 30 may be aged in a state in which each acrylic pressure-sensitive adhesive layer 30 is sandwiched between the release liner and the base member 20 so as to further advance the cross-linking reaction.

The double-sided adhesive tape 10 according to the present embodiment may be configured in various kinds of shapes, examples of which include a roll-shaped structure, sheet-shaped structure, and so forth. The double-sided adhesive tape 10 can be used in the affixation of components of portable electronic devices such as cellular phone terminals, PHS, digital cameras, electronic organizers, portable music players, portable game machines, smart phones, tablet personal computers, and so forth. Specifically, the double-sided adhesive tape 10 can preferably be used to affix a protecting lens configured to protect a display device such as a liquid crystal display device or the like, to affix a camera lens, to affix a casing on another casing, to affix a sheet-type numeric keypad on a casing, to affix a touch panel input device on a casing, to affix a decorative sheet on a casing, and to affix other kinds of components, modules, and so forth.

As described above, the double-sided adhesive tape 10 according to the present embodiment is configured using a non-foamed thermoplastic film, and includes the base member 20 having a thickness of 50 μm or more and acrylic pressure-sensitive adhesive layers 30 respectively provided to both faces of the base member 20. Such a double-faced tape 10 exhibits a 50% modulus ranging from 3.0 MPa or more to 40.0 MPa or less. Thus, such an arrangement provides an advantage that the double-sided adhesive tape 10 can be easily adhered to an adhesion target even if the double-sided adhesive tape 10 is configured as a thick tape structure, and an advantage of workability in the manufacturing of the double-sided adhesive tape 10 even if it has a narrow-width part. In particular, the double-sided adhesive tape 10 according to the present embodiment is capable of providing improved workability and improved adhesion even if it is configured as a thick double-sided adhesive tape having a thickness of 0.100 mm or more. Thus, the double-sided adhesive tape 10 can be suitably used in the affixation of components of portable electronic devices. Furthermore, the base member is formed of a non-foamed material, thereby reducing costs as compared with an arrangement employing a foamed material.

### EXAMPLES

Detailed description will be made below with reference to examples. However, the present invention is by no means restricted to such examples.

### [Preparation of Acrylic Copolymer]

2.9 parts by mass of acrylic acid, 5 parts by mass of vinyl acetate, 92 parts by mass of butyl acrylate, and 0.1 parts by mass of hydroxyethyl acrylate, and, as a copolymerization solvent, 30 parts by mass of ethyl acetate and 120 parts by mass of toluene, were input to a reaction container including a stirrer, a reflux condenser, a thermometer, a dripping device, and a nitrogen inlet pipe, and the materials thus input were stirred for 2 hours while introducing nitrogen gas into the reaction container. After the oxygen contained in the copolymer system was removed by means of nitrogen substitution, 0.2 parts by mass of AIBN (2,2′-azobisisobutyronitrile) were further added to the reaction container, and a copolymerization reaction was performed for 6 hours after the temperature was raised to 60° C. As a result, the acrylic copolymer thus obtained contained solid content of 40.0% by weight, having a weight-average molecular weight of 500,000.

### [Preparation of Acrylic Pressure-Sensitive Adhesive Composition]

4 g of rosin resin (manufactured by Arakawa Chemical Industries, Ltd., trade name “Pencell D-125”, solid content of 100% by weight), 4 g of rosin resin (manufactured by Arakawa Chemical Industries, Ltd., trade name “Super Ester A-100”, solid content of 100% by weight), 2 g of rosin resin (manufactured by Eastman Chemical Company, trade name “Foralyn 8020F”, solid content of 100% by weight), and 6 g of terpene phenol resin (manufactured by Arakawa Chemical Industries, Ltd., trade name “Tamanol 803L”, solid content of 100% by weight), were added to the 100 g of acrylic copolymer thus obtained, and were sufficiently stirred until the resin was dissolved. Next, as a cross-linking agent, 1.1 g of aromatic polyisocyanate (manufactured by Nippon Polyurethane Industry Co. Ltd., trade name “Coronate L”, solid content of 75% by weight) was added to the solution, and the mixture is sufficiently stirred. After the aforementioned process, solvent-type acrylic pressure-sensitive adhesive composition was obtained.

### Example 1

The silicone-treated inner surface of a paper separator having a thickness of 135 μm (manufactured by Sumika-Kakoushi Co. Ltd., trade name “SLB-80WD”) was coated with the acrylic pressure-sensitive adhesive composition such that the coating thickness would become 25 μm after drying, and was dried at 100° C. for 2 minutes. Next, the acrylic pressure-sensitive adhesive layer thus obtained was adhered to a film base member having a thickness of 100 μm formed of a low-density polyethylene subjected to double-faced corona treatment. Specifically, the film base member was formed of a low-density polyethylene (manufactured by Tosoh Corporation, trade name “Petrosen 186R”) using co-extrusion by means of an inflation molding method. As a result, a layered structure a was obtained having a structure in which the paper separator, the acrylic pressure-sensitive adhesive layer, and the base member, were layered.

Next, the silicone-treated outer surface of a paper separator having a thickness of 135 μm (manufactured by Sumika-Kakoushi Co. Ltd., trade name “SLB-80WD”) was coated with the acrylic pressure-sensitive adhesive composition such that the coating thickness would become 25 μm after drying, and was dried at 100° C. for 2 minutes. As a result, a layered structure b was obtained having a structure in which the acrylic pressure-sensitive adhesive layer and the paper separator were layered. Subsequently, the layered structure a and the layered structure b were bonded together such that the base member face of the layered structure a faced the acrylic pressure-sensitive adhesive layer face of the layered structure b, thereby obtaining a double-sided adhesive tape having an overall thickness of 150 μm. The double-sided adhesive tape manufactured in the example 1 is a transparent tape.

### Example 2

The same manufacturing process as in Example 1 was performed except that, in Example 2, as the base member, a film base member having a thickness of 150 μm formed of a low-density polyethylene subjected to double-faced corona treatment, and specifically formed of a low-density polyethylene material (manufactured by Tosoh Corporation, trade name “Petrosen 225”) using co-extrusion by means of an inflation molding method, was employed. As a result, a double-sided adhesive tape having an overall thickness of 200 μm was manufactured. The double-sided adhesive tape thus manufactured in Example 2 is a transparent tape.

### Example 3

The same manufacturing process as in Example 1 was performed except that, in Example 3, as the base member, a film base member having a thickness of 180 μm formed of a low-density polyethylene subjected to the double-faced corona treatment, and specifically formed of a low-density polyethylene material (manufactured by Nippon Polyethylene Industry Co. Ltd., trade name “NOVATEC LD LF440HB”) using co-extrusion by means of an inflation molding method, was employed, and the acrylic pressure-sensitive adhesive layer was formed such that the coating film thickness would become 35 μm after drying. As a result, a double-sided adhesive tape having an overall thickness of 250 μm was manufactured. The double-sided adhesive tape thus manufactured in Example 3 is a transparent tape.

### Example 4

The same manufacturing process as in Example 1 was performed except that, in Example 4, a black film base member having a thickness of 100 μm formed of a low-density polyethylene subjected to double-faced corona treatment was employed. Specifically, the black film base member was formed by adding 20 parts by mass of carbon black (manufactured by Tokai Carbon co., Ltd., trade name “TOKABLACK #8500/F”) to 100 parts by mass of a low-density polyethylene material (manufactured by Nippon Polyethylene Industry Co. Ltd., trade name “NOVATEC LD LF440HB”), and by molding the mixture using co-extrusion by means of an inflation molding method. As a result, a double-sided adhesive tape having an overall thickness of 150 μm was manufactured. The double-sided adhesive tape thus manufactured in Example 4 is a black tape.

### Example 5

The same manufacturing process as in Example 1 was performed except that, in Example 5, a white film base member having a thickness of 100 μm formed of a low-density polyethylene subjected to double-faced corona treatment was employed. Specifically, the white film base member was formed by adding 30 parts by mass of titanium oxide (manufactured by Sakai Chemical Industry Co. Ltd., trade name “R-21”) to 100 parts by mass of a low-density polyethylene material (manufactured by Nippon Polyethylene Industry Co. Ltd., trade name “NOVATEC LD LF440HB”), and by molding the mixture using co-extrusion by means of an inflation molding method. As a result, a double-sided adhesive tape having an overall thickness of 150 μm was manufactured. The double-sided adhesive tape thus manufactured in Example 5 is a white tape.

### Comparison Example 1

The same manufacturing process as in Example 1 was performed except that, in Comparison example 1, a film member having a thickness of 100 μm formed of polyester (manufactured by Toray Industries Inc., trade name “Lumirror#100SIN”) is employed as the base member. As a result, a double-sided adhesive tape having an overall thickness of 150 μm was manufactured.

### Comparison Example 2

The same manufacturing process as in Example 1 was performed except that, in Comparison example 2, a film member having a thickness of 125 μm formed of polyester (manufactured by Toray Industries Inc., trade name “Lumirror#125 E20”) is employed as the base member. As a result, a double-sided adhesive tape having an overall thickness of 175 μm was manufactured.

### Comparison Example 3

The same manufacturing process as in Example 1 was performed except that, in Comparison example 3, a film member having a thickness of 188 μm formed of polyester (manufactured by Toray Industries Inc., trade name “Lumirror #188 E20”) was employed as the base member, and each acrylic adhesive layer was formed such that its coating film thickness would become 31 μm after drying. As a result, a double-sided adhesive tape having an overall thickness of 250 μm was manufactured.

### Comparison Example 4

The same manufacturing process as in Example 1 was performed except that, in Comparison example 4, a polyethylene foam base member having a thickness of 200 μm (manufactured by Sekisui Chemical Co., Ltd., trade name “Volara XL-H #05002 Shorikuro”) was employed as the base member. As a result, a double-sided adhesive tape having an overall thickness of 250 μm was manufactured.

The following evaluation tests were performed for each of the double-sided adhesive tapes formed in the aforementioned respective examples and the aforementioned respective comparison examples after aging for 24 hours in the 50° C. atmosphere.

### [Measurement of Thickness]

Thickness measurement was performed using a 1/1000-increment dial gauge for each of the double-sided adhesive tapes formed in the aforementioned respective examples and the aforementioned respective comparison examples. The measurement results are listed in Table 1.

### [Measurement of 50% Modulus]

Measurement of the 50% modulus was performed according to JIS Z 0237 (1991.6). That is to say, each double-sided adhesive tape was cut to a size of 10 mm in width and 150 mm in length, thereby forming a test sample piece. Subsequently, the test sample piece having a test length of 100 mm was elongated at a tension rate of 300 mm/minute up to 150 mm using a tensile testing machine (manufactured by Shimadzu Corporation, trade name “Tensilon”) under a measurement environment in which the temperature and the relative humidity were maintained at 23° C. and 50%, respectively. In this state, the tensile force per unit cross-sectional area (N/mm², MPa) is defined as the 50% modulus. It should be noted that, because the measurement result does not change even if the measurement width is changed, in a case in which the tensile force to be measured exceeds the performance of the tensile testing machine, the same measurement is performed for a test sample piece formed with a reduced width, e.g., with a width of 5 mm or 3 mm.

### [Pressure-Sensitive Adhesive Force Test]

For each of the double-sided adhesive tapes formed in the aforementioned respective examples and the aforementioned respective comparison examples, the release liner provided to one of its faces was peeled off, and it was backed by adhering this one face to a polyethylene terephthalate (PET) film having a thickness of 25 μm. Each double-sided adhesive tape thus backed was cut to a size of 20 mm in width and 100 mm in length, thereby forming a test sample piece. Subsequently, the release liner provided to the other face of the test sample piece was peeled off, the test sample piece was attached to a SUS304 BA plate prepared as an adhesion target, and the test sample piece and the SUS304 BA plate were bonded together by pressure bonding using a reciprocating movement through a 2-kg roller. After the bonding step, after 20 minutes elapsed under a measurement environment in which the temperature and the relative humidity were maintained at 23° C. and 50%, respectively, the pressure-sensitive adhesive force (N/20 mm) was measured using a tensile testing machine (manufactured by Shimadzu Corporation, trade name “Tensilon”) under a measurement condition in which the tension rate was maintained at 300 mm/minute, and the tension angle was maintained at 180°.

### [Loop Repulsion Test]

Description will be made with reference to FIGS. 2A and 2B regarding a loop repulsion test. FIG. 2A is a schematic diagram showing a method for a loop repulsion test. FIG. 2B is an enlarged view of the region A shown in FIG. 2A surrounded by the broken line.

First, for each of the double-sided adhesive tapes formed in the aforementioned respective examples and the aforementioned respective comparison examples, each double-sided adhesive tape was cut to a size of 10 mm in width and 50 mm in length, thereby forming a test sample piece 100. Next, the release liner provided to one of the faces of each test sample piece 100 was peeled off, one end 100b of the test sample piece 100 was attached to one main face 200b of a polycarbonate resin plate 200 prepared as an adhesion target, and they were bonded together by pressure bonding using a reciprocating movement through a 2-kg roller. The test sample piece 100 was adhered to one main surface 200b of the polycarbonate resin plate 200 in a range of 20 mm from a corner 200e at which the main surface 200b intersected a side face 200c which was positioned on the loop side of the test sample piece 100 (description will be made later regarding the “loop”).

Furthermore, the test sample piece 100 was bent into a loop shape such that the face from which the release liner had been peeled off functioned as the inner face of the loop. Furthermore, the other end 100a of the test sample piece 100 was attached to the other main surface 200a of the polycarbonate resin plate 200, and they were bonded together by pressure bonding using a reciprocating movement through a 2-kg roller. The test sample piece 100 was adhered to the other main surface 200a of the polycarbonate resin plate 200 in a range of 2 mm from a corner 200d at which the other main surface 200a intersected the side face 200c. In this stage, baby powder was applied to the pressure-sensitive adhesive layer face which was not to be adhered to the polycarbonate resin plate such that a portion of the test sample piece 100 bent in a loop shape would remain unadhered. After the adhesion of the test sample piece 100, the other release liner of the test sample piece 100 was peeled off.

The lifting distance was measured using a digital microscope (manufactured by Keyence Corporation, trade name “VH-500”) for each of the test samples manufactured using the aforementioned methods immediately after the adhesion of the double-sided adhesive tape (initial state). Next, the test sample piece was left for 72 hours under an environment in which the temperature and the relative humidity were maintained at 23° C. and 50%, respectively, with a portion of the adhesive face of the test sample piece 100 remaining unadhered. Subsequently, after the test sample was left for 2 hours in an oven at a temperature of 70° C., the lifting distance was again measured using the digital microscope. Thus, the difference (lifting distance difference) in the lifting distance between the initial state and the state after the test sample was left at 70° C. for 2 hours was obtained.

It should be noted that the “lifting distance” in the loop repulsion test represents a distance between the corner 200d of the polycarbonate resin plate 200 and an intersection 100d at which the line L that is orthogonal to the main surface 200a intersects the main surface of the test sample piece 100. The measurement results are shown in Table 1. It should be noted that, in Table 1, the symbol “X” represents a state in which the end 100a of the test sample piece 100 is completely detached from the polycarbonate resin plate 200.

### [Measurement of Punching Process Error]

Punching processing was performed for each of the double-sided adhesive tapes formed in the aforementioned respective examples and the aforementioned respective comparison examples using a frame-shaped punching die having a size of 40 mm×60 mm and a frame width of 0.5 mm. The width of each double-sided adhesive tape thus processed was measured using a digital microscope. The difference between the smallest measurement width and the frame width, i.e., 0.5 mm, was compared with the difference between the largest measurement width and the frame width, i.e., 0.5 mm, and the punching process error (%) was calculated using the greater of the two based upon the following Expression.

Error(%)=[(0.5−minimum measurement width) or (maximum measurement width−0.5)/0.5×100]

TABLE 1

| | | | EX- | EX- | EX- | COM- | COM- | COM- | COM- |
|---|---|---|---|---|---|---|---|---|---|
| | EXAMPLE | EXAMPLE | AMPLE | AMPLE | AMPLE | PARISON | PARISON | PARISON | PARISON |
| | 1 | 2 | 3 | 4 | 5 | EXAMPLE 1 | EXAMPLE 2 | EXAMPLE 3 | EXAMPLE 4 |
| TAPE THICKNESS | 0.15 | 0.20 | 0.25 | 0.15 | 0.15 | 0.15 | 0.18 | 0.25 | 0.25 |
| (mm) | | | | | | | | | |
| 50% MODULUS | 15.7 | 14.7 | 14.1 | 16.3 | 16.1 | 73.9 | 100.0 | 90.2 | 1.2 |
| (MPa) | | | | | | | | | |
| PRESSURE-SENSITIVE | 15.2 | 18.0 | 21.5 | 15.7 | 15.3 | 14.2 | 17.1 | 19.8 | 21.0 |
| ADHESIVE FORCE | | | | | | | | | |
| (N/20 mm) | | | | | | | | | |
| LIFTING DISTANCE | 0.0 | 0.0 | 0.5 | 0.0 | 0.5 | 5.0 | x | x | 0.1 |
| DIFFERENCE | | | | | | | | | |
| (mm) | | | | | | | | | |
| PUNCHING | 1.0 | 1.0 | 2.0 | 1.0 | 1.0 | 1.0 | 1.0 | 2.0 | 20.9 |
| PROCESS ERROR | | | | | | | | | |
| (%) | | | | | | | | | |

As shown in Table 1, Comparison examples 1 to 3 employing a polyester base member each exhibited a 50% modulus that was greater than 40.0 MPa, leading to an increased lifting distance. That is to say, such an arrangement provided poor adhesion to an adhesion target. Comparison example 4 employing a polyethylene foam base member exhibited a 50% modulus that was smaller than 3.0 MPa, which provided a small lifting distance, thereby providing satisfactory adhesion to the adhesion target. However, such an arrangement has a problem of increased punching process error, leading to poor workability. In contrast, the double-sided adhesive tapes manufactured in Examples 1 through 5 each exhibited a 50% modulus ranging from 3.0 MPa or more to 40.0 MPa or less, thereby exhibiting a small lifting distance and small punching process error. That is to say, such an arrangement provides satisfactory adhesion to the adhesion target and satisfactory workability. Thus, it has been affirmed that the double-sided adhesive tapes manufactured in Examples 1 through 5 each have an advantage of satisfactory adhesion to an adhesion target even if the double-sided adhesive tape is configured as a thick tape and an advantage of satisfactory workability even if the double-sided adhesive tape is configured to have a narrow-width part.

The embodiments described above will be summarized below.

### [Item 1]

A double-sided adhesive tape comprising:

a base member having a thickness that is equal to or greater than 50 μm formed of non-foamed thermoplastic film; and

acrylic pressure-sensitive adhesive layers respectively provided to both faces of the base member,

wherein the double-sided adhesive tape has a 50% modulus ranging from 3.0 MPa or more to 40.0 MPa or less.

### [Item 2]

A double-sided adhesive tape described in item 1, wherein a total thickness of the acrylic pressure-sensitive adhesive layers respectively provided to both faces of the base member is within a range of 5 μm or more to 200 μm or less.

### [Item 3]

A double-sided adhesive tape described in item 1 or 2, wherein a total thickness of the base member and the acrylic pressure-sensitive adhesive layers is equal to or greater than 100 μm.

### [Item 4]

A double-sided adhesive tape described in any one of items 1 through 3, wherein the thermoplastic film contains at least one resin selected from a group that comprises a flexible polyolefin resin, a flexible urethane resin, a flexible acrylic resin, a flexible polyester resin, and a flexible vinyl chloride resin.

### [Item 5]

A double-sided adhesive tape described in any one of items 1 through 4, wherein the base member contains substantially no halogen compound.

### [Item 6]

A double-sided adhesive tape described in any one of items 1 through 5, employed in the affixation of components of a portable electronic device.

### [Item 7]

A double-sided adhesive tape described in any one of items 1 through 6, wherein the base member is configured in black.

### [Item 8]

A double-sided adhesive tape described in item 7, wherein the double-sided adhesive tape has a visible light transmissivity that is equal to or smaller than 15%.

### [Item 9]

A double-sided adhesive tape described in any one of items 1 through 6, wherein the base member is configured in white.

### [Item 10]

A double-sided adhesive tape described in item 9, wherein the double-sided adhesive tape has a visible light reflectivity that is equal to or greater than 20%.

What is claimed is:

1. A double-sided adhesive tape comprising:
a base member having a thickness that is equal to or greater than 50 μm formed of non-foamed thermoplastic film; and
acrylic pressure-sensitive adhesive layers respectively provided to both faces of the base member,
wherein the double-sided adhesive tape has a 50% modulus ranging from 3.0 MPa or more to 40.0 MPa or less.

2. A double-sided adhesive tape according to claim 1, wherein a total thickness of the acrylic pressure-sensitive adhesive layers respectively provided to both faces of the base member is within a range of 5 μm or more to 200 μm or less.

3. A double-sided adhesive tape according to claim 1, wherein a total thickness of the base member and the acrylic pressure-sensitive adhesive layers is equal to or greater than 100 μm.

4. A double-sided adhesive tape according to claim 1, wherein the thermoplastic film contains at least one resin selected from a group that comprises a flexible polyolefin resin, a flexible urethane resin, a flexible acrylic resin, a flexible polyester resin, and a flexible vinyl chloride resin.

5. A double-sided adhesive tape according to claim 1, wherein the base member contains substantially no halogen compound.

6. A double-sided adhesive tape according to claim 1, employed in the affixation of components of a portable electronic device.

7. A double-sided adhesive tape according to claim 1, wherein the base member is configured in black.

8. A double-sided adhesive tape according to claim 7, wherein the double-sided adhesive tape has a visible light transmissivity that is equal to or smaller than 15%.

9. A double-sided adhesive tape according to claim 1, wherein the base member is configured in white.

10. A double-sided adhesive tape according to claim 9, wherein the double-sided adhesive tape has a visible light reflectivity that is equal to or greater than 20%.

11. A double-sided adhesive tape according to claim 2, wherein a total thickness of the base member and the acrylic pressure-sensitive adhesive layers is equal to or greater than 100 μm.

12. A double-sided adhesive tape according to claim 2, wherein the thermoplastic film contains at least one resin selected from a group that comprises a flexible polyolefin resin, a flexible urethane resin, a flexible acrylic resin, a flexible polyester resin, and a flexible vinyl chloride resin.

13. A double-sided adhesive tape according to claim 3, wherein the thermoplastic film contains at least one resin selected from a group that comprises a flexible polyolefin resin, a flexible urethane resin, a flexible acrylic resin, a flexible polyester resin, and a flexible vinyl chloride resin.

14. A double-sided adhesive tape according to claim 11, wherein the thermoplastic film contains at least one resin selected from a group that comprises a flexible polyolefin resin, a flexible urethane resin, a flexible acrylic resin, a flexible polyester resin, and a flexible vinyl chloride resin.

15. A double-sided adhesive tape according to claim 2, wherein the base member contains substantially no halogen compound.

16. A double-sided adhesive tape according to claim 3, wherein the base member contains substantially no halogen compound.

17. A double-sided adhesive tape according to claim 4, wherein the base member contains substantially no halogen compound.

18. A double-sided adhesive tape according to claim 11, wherein the base member contains substantially no halogen compound.

19. A double-sided adhesive tape according to claim 12, wherein the base member contains substantially no halogen compound.

20. A double-sided adhesive tape according to claim 13, wherein the base member contains substantially no halogen compound.
